(19) United States
(12) Patent Application Publication
(10) Pub. No.: US 2007/0269551 A1
(43) Pub. Date: Nov. 22, 2007

(54) Mold structure of spike

(76) Inventor: I-Chung Liao, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/435,719

(22) Filed: May 18, 2006

(51) Int. Cl. B29C 45/00

(52) U.S. Cl. 425/577; 425/542

(57) ABSTRACT

A mold structure of a spike comprises a male mold base and a female mold base, and the female mold base is corresponded to the male mold base. The female mold base comprises a first female mold, a second female mold, a third female mold and a thimble. The first female mold is fixed on the female mold base, and the first female mold is formed a through hole therein; the second female mold is penetrated into the through hole of the first female mold, and the second female mold is formed a through hole therein; the third female mold is penetrated into the through hole of the second female mold, and the third female mold is formed a through hole therein. And the thimble is disposed on a thimble base, and correspondingly penetrated into the through hole of the third female mold.

### BACKGROUND OF THE INVENTION

1. Field of the Invention

The present invention relates to a mold structure of a spike, and more particularly to the mold structure of the spike with a tightly matched effect.

2. Description of the Prior Art

Generally speaking, there are two steps of manufacturing for a connecting portion and a nail portion of the spike. The first step is to manufacture the connection portion and the next step is to form the nail portion on the connecting portion. If the connecting portion is a metal material, the nail portion is a one-step model from the connecting portion; if the connecting portion is a polymer material, the connecting portion is formed from a machine and the nail portion is formed from another machine. However, if the nail portion is formed to two colors or the connecting portion and the nail portion are sequentially formed from the same machine, it is need to have a two-step model.

Reference is made to FIG. 1 which is a perspective view of a spike structure of the prior art. The conventional spike 100 comprises a connecting portion 101 and a nail portion 102. A connection strength of a border between the connecting portion 101 and the nail portion 102 is weaker, and the connecting portion 101 of the spike 100 can't be tightly matched to fall off during use so that the users are injured.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a mold structure of a spike that a second female mold and a third female mold are penetrated into a first female mold, and a second supporting portion is mutually fastened with a first supporting portion so that a connecting portion of the spike can be fastened with the second supporting portion and the first supporting portion for improving a connection strength of a border between the connecting portion and a nail portion of the spike that without falling off during using.

For achieving the primary objective stated above, the mold structure of the spike of present invention comprises a male mold base; a female mold base is corresponded to the male mold base. The female mold base comprises a first female mold is fixed on the female mold base, and the first female mold is formed a through hole therein; a second female mold is penetrated into the through hole of the first female mold, and the second female mold is formed a through hole therein; a third female mold is penetrated into the through hole of the second female mold, and the third female mold is formed a through hole therein. And a thimble is disposed on a thimble base, and correspondingly penetrated into the through hole of the third female mold.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a perspective view of a spike structure of the prior art;

FIG. 2 is a perspective view of a spike structure of the present invention;

FIG. 3 is a schematic view of a mold structure of a spike for a male mold base corresponding to a female mold base of the present invention;

FIG. 4 is an exploded perspective view of a first female mold, a second female mold and a third female mold of the mold structure of the spike of the present invention;

FIG. 5 is a cross-sectional view of the first female mold of the mold structure of the spike of the present invention;

FIG. 6 is a cross-sectional view of the second female mold of the mold structure of the spike of the present invention;

FIG. 7 is a cross-sectional view of the third female mold of the mold structure of the spike of the present invention;

FIG. 8 is a perspective view of a male mold of the mold structure of the spike of the present invention; and

FIG. 9 is a perspective view of an external female mold of the mold structure of the spike of the present invention.

The drawings will be described further in connection with the following detailed description of the present invention.

### DETAILED DESCRIPTION OF THE PREFERRED EMBODIMENTS

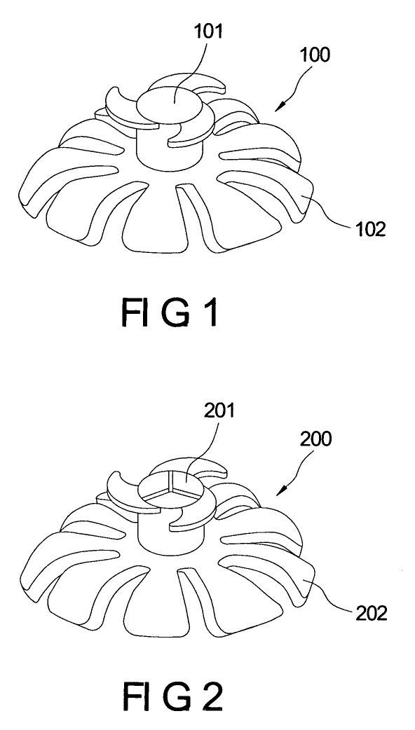

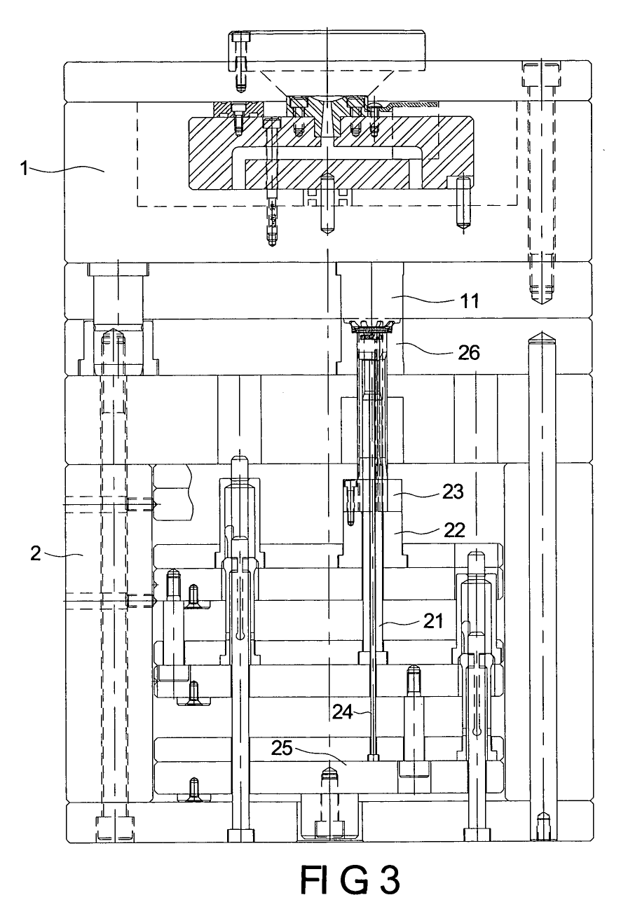

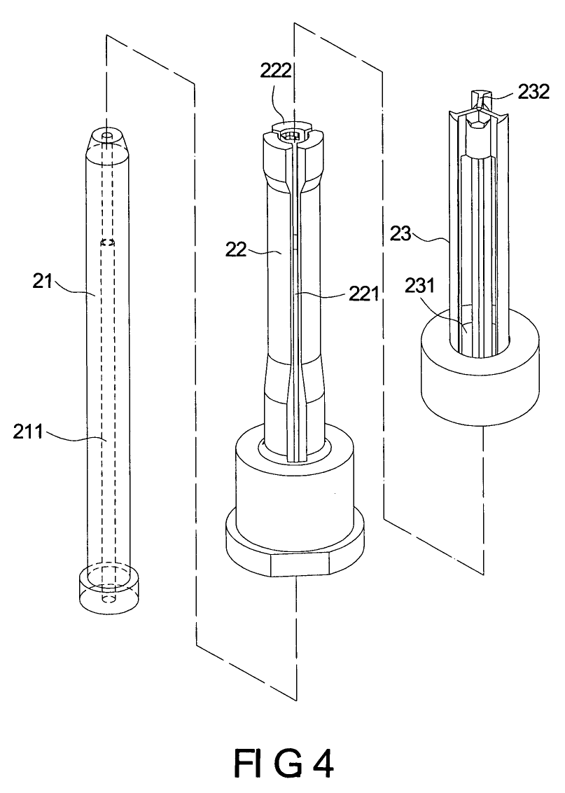

Reference is made to FIG. 1 which is a schematic view of a mold structure of a spike for a male mold base corresponding to a female mold base of the present invention. The mold structure of the spike comprises a male mold base 1 and a female mold base 2, and the female mold base 2 is corresponded to the male mold base 1. The male mold base 1 has a male mold 11, and the male mold 11 has a runner 111. The female mold base 2 comprises a first female mold 23, a second female mold 22, a third female mold 21 and a thimble 24. The first female mold 23 is fixed on the female mold base 2, and the first female mold 23 is formed a through hole 231 therein; the second female mold 22 is penetrated into the through hole 231 of the first female mold 23, and the second female mold 22 is formed a through hole 221 therein; the third female mold 21 is penetrated into the through hole 221 of the second female mold 22, and the third female mold 21 is formed a through hole 211 therein. And the thimble 24 is disposed on a thimble base 25, and correspondingly penetrated into the through hole 211 of the third female mold 21.

Reference is made to FIG. 2 which is a perspective view of a spike structure of the present invention. The spike 200 has a connecting portion 201 and a nail portion 202. A middle of the connecting portion 201 has gaps for forming a buffer space to provide a tightly matched effect without falling off during using.

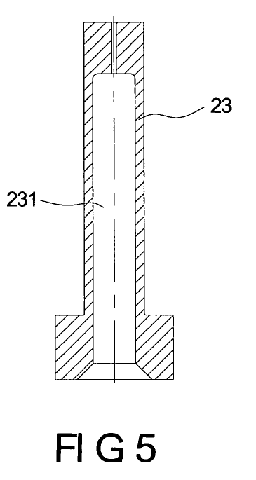

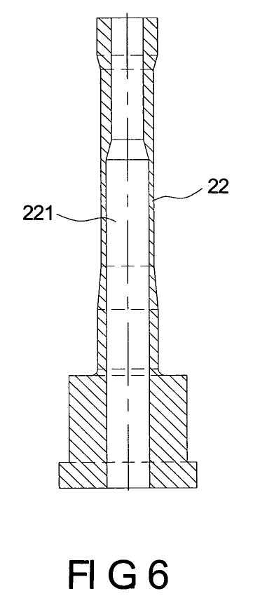

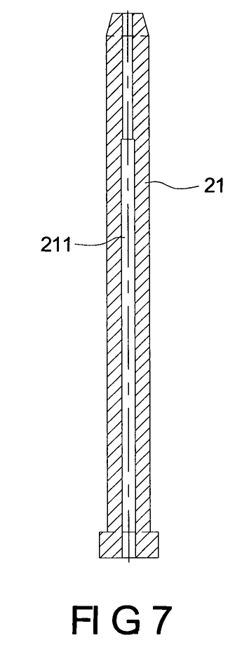

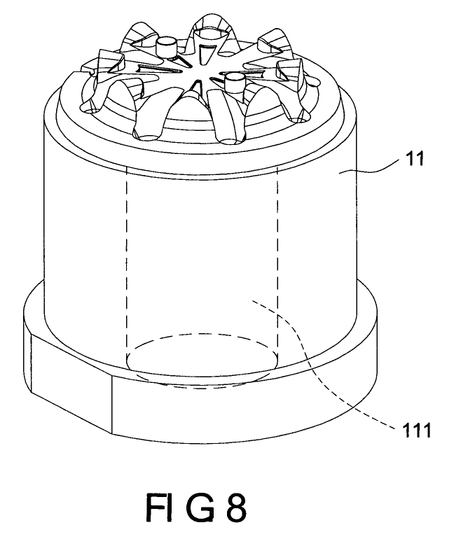

References are made from FIG. 4 to FIG. 7 which are separately exploded perspective view and cross-sectional view of the first female mold 23, the second female mold 22 and the third female mold 21. The first female mold 23, the second female mold 22 and the third female mold 21 are separately formed the through hole 231, the through hole 221 and the through hole 211. The first female mold 23 has a first supporting portion 232 on a top end thereof, the second female mold 22 has a second supporting portion 222 on a top end thereof, and the second supporting portion 222 is penetrated into the through hole 231 of the first female mold 23 and is mutually fastened with the first supporting portion 232 so that the connecting portion 201 of the spike 200 is appropriately fastened with the second supporting portion 222 and the first supporting portion 232.

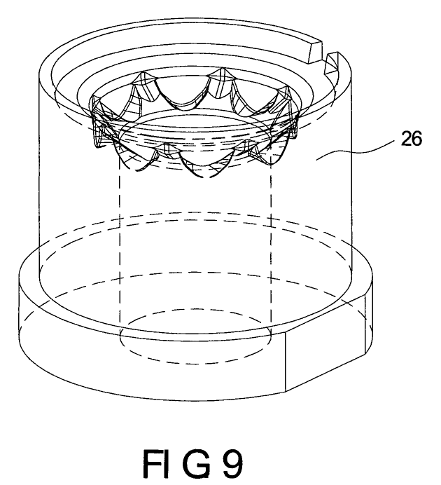

References are made to FIG. 8 and FIG. 9 which are separately perspective view of the male mold and an external female mold of the mold structure of the spike of the present invention. The male mold 11 has a runner 111. The first female mold 23 is fixed on the female mold base 2, and the first female mold 23 is formed a through hole 231 therein; the second female mold 22 is penetrated into the through hole 23 of the first female mold 23, and the second female mold 22 is formed a through hole 221 therein; the third female mold 21 is penetrated into the through hole 221 of the second female mold 22, and the third female mold 21 is formed a through hole 211 therein. When the male mold 11 is associated with the external female mold 26, the plastic material is injected into the runner 111 of the male mold 11 for forming the nail portion 202. Furthermore, the thimble 24 is penetrated into the through hole 211 of the third female mold 21 for pushing the spike 200 formed.

It follows from what has been said that the mold structure of the spike, the second female mold 22 and the third female mold 21 are penetrated into the through hole 231 of the first female mold 23, and the second supporting portion 222 is mutually fastened with the first supporting portion 232 for fastening the connecting portion 201 of the spike 200 on the second supporting portion 222 and the first supporting portion 232. Whereby it is to improve a connection strength of a border between a connecting portion and a nail portion of the conventional spike that without falling off during using.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mold structure of a spike, comprising:
a male mold base;
a female mold base corresponded to the male mold base, and having:
a first female mold fixed on the female mold base, and the first female mold formed a through hole therein;
a second female mold penetrated into the through hole of the first female mold, and the second female mold formed a through hole therein;
a third female mold penetrated into the through hole of the second female mold, and the third female mold formed a through hole therein; and
a thimble disposed on a thimble base, and correspondingly penetrated into the through hole of the third female mold.

2. The mold structure of the spike as in claim 1, wherein the male mold base has a male mold.

3. The mold structure of the spike as in claim 2, wherein the male mold has a runner for injecting into plastic material.

4. The mold structure of the spike as in claim 2, wherein the female mold base further comprises an external female mold is associated with the male mold.

5. The mold structure of the spike as in claim 1, wherein the first female mold has a first supporting portion on a top end thereof.

6. The mold structure of the spike as in claim 3, wherein the second female mold has a second supporting portion on a top end thereof, and the second supporting portion is penetrated into the through hole of the first female mold and is mutually fastened with the first supporting portion.

7. The mold structure of the spike as in claim 1, further comprising a spike, and the spike having a connecting portion and a nail portion.
